(19) United States
(12) Patent Application Publication
(10) Pub. No.: US 2011/0227823 A1
(43) Pub. Date: Sep. 22, 2011

(54) PUCK-TYPE POINTING APPARATUS, POINTING SYSTEM, AND POINTING METHOD

(75) Inventors: Yong-Hwan Kim, Yongin-si (KR); Jin-Woo Chung, Yongin-si (KR); Bang-Won Lee, Yongin-si (KR)

(73) Assignee: ATLAB INC., Yongin-si (KR)

(21) Appl. No.: 13/128,794

(22) PCT Filed: Mar. 16, 2009
(86) PCT No.: PCT/KR2009/001297

§ 371 Date: May 11, 2011

(30) Foreign Application Priority Data
Dec. 8, 2008 (KR) 10-2008-0124143

(51) Int. Cl. G06F 3/033

(52) U.S. Cl. 345/157

(57) ABSTRACT

Provided are a puck-type pointing device, a pointing system including the same, and a pointing method thereof. The puck-type pointing device includes a movement detection unit detecting information regarding touch and movement of a puck by a touch object and outputting a movement detection signal, a first signal processing unit receiving the movement detection signal, removing noise, and outputting a first puck movement signal after a first period of time, a second signal processing unit receiving the movement detection signal, removing noise, and outputting a second puck movement signal after a second period of time which is shorter than the first period of time, and a puck movement signal transmitting unit transmitting or cutting off the first puck movement signal according to the movement information in response to the second puck movement signal.

### BACKGROUND OF THE INVENTION

1. Field of the Invention

The present invention relates to a pointing device, a pointing system, and a pointing method, and more particularly, to a puck-type pointing device, a pointing system including the same, and a pointing method thereof, which can quickly and accurately move the position of a cursor on a display connected to the puck-type pointing device based on position information of a puck in the puck-type pointing device.

2. Description of the Related Art

Conventional pointing devices for controlling the position of a cursor on a display include arrow keys, function keys, mice, tracking balls, joysticks, touch screens, light pens, tablets, and other similar devices for controlling cursor movement and selecting items or functions on the display.

Although these conventional pointing devices are generally satisfactory for many applications, in environments where the pointing device must operate in a limited workspace and fit within the form factor of an electronic device, such as a laptop computer, personal digital assistant (PDA), wired or wireless telephone, video game, or other similar electronic device, the conventional pointing devices do not provide sufficient cursor control speed or accuracy.

Recently, puck-type pointing devices have been introduced to the laptop computer and hand-held devices to overcome many of the limitations of earlier pointing devices.

The puck-type pointing devices include a compact disk-shaped unit attached with a knob that may be manipulated by a user's finger to move within a puck field of motion. The position of the puck in the puck field of motion is detected using a variety of electrical, electromagnetic, and optical techniques. And the position of the puck is mapped to a cursor position on a display.

That is, when a user applies pressure to the puck by the user's finger, the puck moves in a defined field of motion, and when the user releases the puck, an elastic member such as a set of springs returns the puck to its center position within the field of motion.

The position of the puck and the pressure on the puck are determined by electrodes in the device. The position information is transmitted to a host device connected to the pointing device including the puck and is used to position a cursor on the display screen. The host device includes software for converting the motion of the puck during the time the user's finger is pressing on the puck into the appropriate cursor motion on the device's display.

FIG. 1 is a top view of a conventional puck-type pointing device 10, which includes a puck 11, a puck field of motion 19, springs 13, and a side 14 of the puck field of motion.

FIG. 2 is a cross-sectional view of the pointing device 10, taken along line 1-2 shown in FIG. 1, in which the puck 11, the springs 13, the side 14 of the puck field of motion, a substrate 17, and a user's finger 16 are shown.

Operation of the conventional puck-type pointing device 10 will be described with respect to FIGS. 1 and 2 below.

The puck 11 moves over a surface 12 of the substrate 17 within the puck field of motion 19 in response to a lateral force applied thereto. The force is typically applied to the puck 11 by the user's finger 16. The puck 11 includes a pressure sensing mechanism for measuring the vertical pressure applied thereto. The pointing device 10 includes a sensing mechanism for determining the position of the puck 11 on the surface 12.

When the user releases the puck 11 by removing the user's finger 16, the puck 11 is returned to its center position by the springs 13 that connect the puck 11 to the side 14 of the puck field of motion. Accordingly, in a joystick mode, in which the speed of cursor motion is determined by the moving distance of the puck, the returning of the puck 11 to its center position causes to reduce the speed of cursor motion.

On the other hand, in a mouse mode, in which a moving distance of the cursor is determined by the moving distance of the puck, when the puck 11 is returned to its center position, the cursor is also returned to its original position.

To solve the above problems, the conventional puck-type pointing device 10 employs a mechanical structure or a pressure sensor to prevent the cursor from moving in the mouse mode by detecting that the user's finger does not apply a vertical force to the puck 11 while the puck 11 is returned; however, this mechanical structure is problematic in that durability is low and response speed is slow.

FIG. 3 is a top view illustrating an electrical capacitance measurement that yields the position of the puck in the puck-type pointing device 10, in which a surface 50, four surface electrodes 51 to 54, and an electrode 55 of the puck are shown.

The surface 50 includes the four electrodes 51 to 54 having terminals electrically connected to an external circuit, the electrodes 51 to 54 being electrically isolated from one another, and the puck includes the electrode 55 shown in phantom in FIG. 3. To simplify the drawing, these terminals have been omitted.

Overlapping portions between the electrode 55 of the puck and the surface electrodes 51 to 54 are changed according to the position of the puck. Each of the overlapping portions A to D forms a parallel plate capacitor having a capacitance that is proportional to the overlapping area of each of the overlapping portions A to D.

Accordingly, the position of the electrode 55 of the puck with respect to the surface electrodes 51 to 54 can be calculated by measuring the capacitances between the electrode 55 of the puck and the surface electrodes 51 to 54.

In general, the operation modes of the pointing device include a joystick mode in which a change in movement vector is caused by the moving distance and direction of the puck and a mouse mode in which a change in moving distance is caused by the moving distance and direction of the puck.

That is, in the case where the movement of the puck is measured by the change in capacitance, in the joystick mode, when the puck moves from its center and stops at a specific position, the cursor continues to move, and when the puck returns to its center position, only the speed of cursor motion is reduced since the speed of cursor motion is proportional to the moving distance of the puck. On the other hand, in the mouse mode, when the puck is moved by the user's finger, the cursor moves a distance equal to the moving distance of the puck from its center and then stops moving, and when the user's finger is removed from the puck and thus the puck returns to its center position, the cursor is also returned to its original position.

However, although the puck-type pointing device moves the cursor more quickly and accurately than conventional pointing devices in the portable electronic device industry, the puck-type pointing device is used only in the joystick mode in the case where the puck is connected by the springs as shown in FIG. 1. Thus, in order to move the cursor quickly and accurately, it is necessary that the cursor be moved a distance equal to the moving distance of the puck and then stopped at a position to which it has been moved when the puck returns to its center position.

FIG. 4 is a schematic block diagram of the conventional puck-type point device, which includes a movement detector 5 and a filter 15.

The function of each block will be described below.

The movement detector 5 receives movement information of the puck from a touch object, determines whether the touch object is in contact with the pointing device and the movement of the puck after the touch, and outputs a movement detection signal m_det indicating corresponding capacitance values after a predetermined period of time.

The filter 15 receives the movement detection signal m_det delayed for a predetermined period of time from the movement detector 5, removes noise, and outputs a puck movement signal mov.

FIG. 5 is an operation waveform diagram of the conventional puck-type pointing device of FIG. 4, in which waveform (1) represents the movement detection signal m_det of four channels and waveform (2) represents the puck movement signal mov of four channels. The four channels are caused by the difference in the capacitance values measured at the overlapping portions between the electrode 55 of the puck and the surface electrodes 51 to 54 of FIG. 3.

When the touch object is in contact with the pointing device and moves the puck, the movement detection signal m_det with noise is produced at a high level indicating the corresponding capacitance values after a predetermined period of time T1, and the movement detection signal m_det with reduced noise is produced at a low level indicating the corresponding capacitance values during the period from time point t0 at which the touch object is removed from the pointing device to time point t1 at which the predetermined period of time T1 elapses. Here, T1 is delay time of filter 15.

When the touch object is in contact with the pointing device and moves the puck, the puck movement signal mov from which noise is removed is produced at a high level indicating the corresponding capacitance values after a predetermined period of time T1, and the level of the signal gradually decays from time point t1 at which the predetermined period of time T1 elapses from time point t0 at which the touch object is removed from the pointing device, and then the puck movement signal mov from which noise is removed is produced at a low level indicating the corresponding capacitance values after a predetermined long period of time T2.

Operation of the conventional puck-type pointing device will be described with reference to FIGS. 4 and 5 below.

For example, it is assumed that a user moves a cursor on a monitor of a laptop computer using the puck-type pointing device.

When the user moves a puck in the pointing device with his or her finger, the movement detector 5 receives touch and movement information from the user's finger as the touch object and detects that the touch object is in contact with and moves the puck.

Accordingly, the movement detector 5 outputs the movement detection signal m_det with noise at a high level indicating the corresponding capacitance values, and then the filter 15 receiving the delayed movement detection signal m_det from the movement detector 5 removes noise by low-pass filtering the signal and produces a puck movement signal mov at a high level indicating the corresponding capacitance values after the predetermined period of time T1.

The host device receives the puck movement signal mov of the high level from the filter 15 and moves the cursor on the monitor in accordance with the movement direction of the puck.

Then, when the user's finger is removed from the puck at time point t0, the movement detector 5 recognizes that the pressure applied from the user's finger is rapidly reduced and determines that the touch and movement of the touch object are stopped.

Accordingly, the movement detector 5 outputs the movement detection signal m_det with reduced noise at a low level indicating the corresponding capacitance values, and then the filter 15 receiving the movement detection signal m_det delayed for the predetermined period of time T1 from the movement detector 5 removes noise by low-pass filtering the signal and produces the puck movement signal mov at a low level indicating the corresponding capacitance values.

However, as shown in waveform (2) of FIG. 5, at time point t0 at which the touch and movement of the touch object are stopped in the pointing device, the level of the puck movement signal mov is not turned into a low level and gradually decays for the predetermined period of time T2, and thus the puck movement signal mov without noise is output at a low level indicating the corresponding capacitance values at time point t2 at which a predetermined period of time T2 elapses.

That is, at the time point when the user's finger contacts and moves the puck, the puck movement signal mov from which noise is removed by the filter 15 of FIG. 4 is output at the high level indicating the corresponding capacitance values; however, when the finger is removed from the puck, the measured capacitance values are not rapidly reduced but slowly reduced with a predetermined curve due to the characteristics of the filter 15.

This phenomenon is caused by slow removal of the finger from the puck and also by delay equal to the vibration (chattering) time during which a mechanical switch such as a dome switch located at the bottom of the puck recognizes removal of the finger.

Moreover, as shown in waveforms (1) and (2) of FIG. 5, the reason that there is the difference in four capacitance values in the delayed movement detection signal m_det and the puck movement signal mov is that the puck is not accurately positioned in the center of the four surface electrodes 51 to 54. This phenomenon may be caused by deterioration of the springs due to long-term use of the puck. For simplicity of description, puck returning time by spring 13 is assumed to be small comparing with puck movement.

The host device receiving the puck movement signal mov of the low level from the filter 15 does not move the cursor on the monitor.

As such, the conventional puck-type pointing device should remove the noise generated by the touch and movement of the puck using a predetermined filter; however, even when the user's finger is removed from the puck after moving the puck, the pointing device cannot accurately detect the time point t0 at which touch and movement of the puck stop, due to the time T1 delayed by the filter 15 and the time T2 required for the puck movement signal mov to decay due to the characteristics of the filter.

Up to now, the puck 11 is assumed to be floating so that the touch makes the capacitances increasing. Even if the puck 11 is connected to a ground potential, the noise in the movement detection signal m_det can be reduced but time for touch decision making cursor shake is inevitable.

Accordingly, the cursor that moves in accordance with the movement direction and distance of the puck in the pointing device is not stopped at a precise position but still moves at time point t0 when the puck is no longer being touched and moved.

### SUMMARY OF THE INVENTION

It is, therefore, an object of the present invention to provide a puck-type pointing device in which a cursor moves a distance corresponding to the distance that a puck moves, and when the puck returns to its center position, stops at a precise position at a time point when touch and movement of the puck stop.

Another object of the present invention is to provide a pointing system including the puck-type pointing device for achieving the above object.

Still another object of the present invention is to provide a pointing method of the puck-type pointing device for achieving the above object.

In accordance with one aspect of the present invention, there is provided a puck-type pointing device including: a movement detection unit detecting information regarding touch and movement of a puck by a touch object and outputting a movement detection signal; a first signal processing unit receiving the movement detection signal, removing noise, and outputting a first puck movement signal after a first period of time; a second signal processing unit receiving the movement detection signal, removing noise, and outputting a second puck movement signal after a second period of time which is shorter than the first period of time; and a puck movement signal transmitting unit transmitting or cutting off the first puck movement signal according to the movement information in response to the second puck movement signal.

In accordance with another aspect of the present invention, there is provided a puck-type pointing system including: a puck-type pointing device detecting information regarding touch and movement of a puck by a touch object, filtering with varying a delay time and transmitting or cutting off a first puck movement signal according to the movement information; a host device calculating movement direction and distance of the puck and outputting a cursor control signal in response to the first puck movement signal; and a display device moving a cursor a distance corresponding to the moving distance of the puck in response to the cursor control signal and stopping the cursor at a precise time point at which the movement of the puck stops when the puck returns to its center position.

In accordance with still another aspect of the present invention, there is provided a puck-type pointing method including: a movement detection step of detecting information regarding touch and movement of a puck by a touch object and outputting a movement detection signal; a first signal processing step of receiving the movement detection signal, removing noise, and outputting a first puck movement signal after a first period of time; a second signal processing step of receiving the movement detection signal, removing noise, and outputting a second puck movement signal after a second period of time which is shorter than the first period of time; and a puck movement signal transmitting step of transmitting or cutting off the first puck movement signal according to the movement information in response to the second puck movement signal.

### BRIEF DESCRIPTION OF THE DRAWINGS

FIG. 1 is a top view of a conventional puck-type pointing device.

FIG. 2 is a cross-sectional view of the pointing device, taken along line 1-2 of FIG. 1.

FIG. 3 is a top view illustrating an electrical capacitance measurement that yields the position of a puck in the puck-type pointing device.

FIG. 4 is a schematic block diagram of the conventional puck-type pointing device.

FIG. 5 is an operation waveform diagram of the conventional puck-type pointing device of FIG. 4.

FIG. 6 is a schematic block diagram of a puck-type pointing device in accordance with an exemplary embodiment of the present invention.

FIG. 7 is a schematic block diagram of a pointing system including the puck-type pointing device in accordance with the exemplary embodiment of the present invention of FIG. 6.

FIG. 8 is an operation waveform diagram of the puck-type pointing device in accordance with the exemplary embodiment of the present invention of FIG. 6.

FIG. 9 is a cross-sectional view of the puck-type pointing device of FIG. 1 to which another exemplary embodiment of the present invention is applied, taken along line 1-2.

### DETAILED DESCRIPTION OF THE INVENTION

Hereinafter, a puck-type pointing device, a pointing system including the same, and a pointing method thereof in accordance with the present invention will be described with reference to the accompanying drawings.

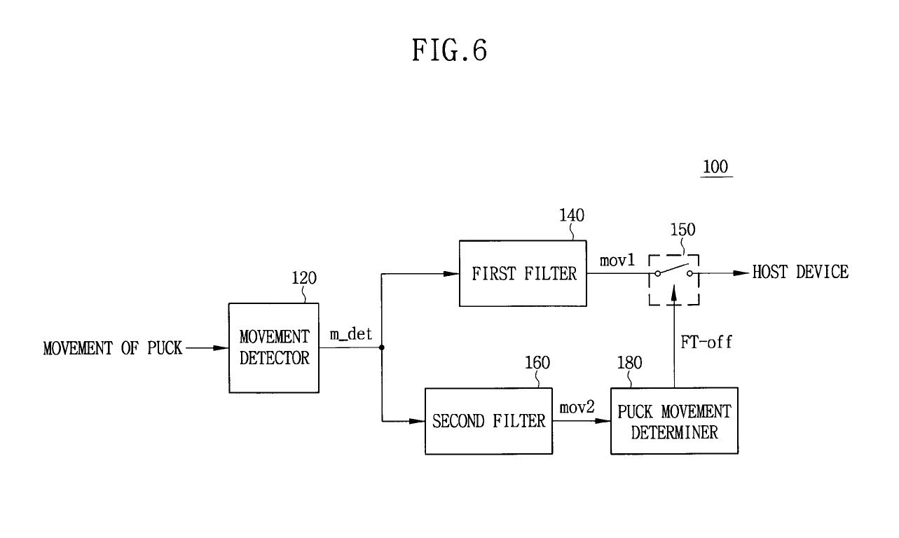

FIG. 6 is a schematic block diagram of a puck-type pointing device 100 in accordance with an exemplary embodiment of the present invention, which includes a movement detector 120, first and second filters 140 and 160, a puck movement determiner 180, and a switch 150.

The function of each block will be described below.

The movement detector 120 detects information regarding touch and movement of a puck by a touch object, determines whether the touch object is in contact with the puck and the movement direction and direction of the puck after the touch, and outputs a movement detection signal m_det indicating corresponding capacitance values.

The first filter 140 receives the movement detection signal m_det delayed for a predetermined period of time from the movement detector 120, removes noise, and outputs a first puck movement signal mov1 after a first period of time.

The second filter 160 receives the movement detection signal m_det from the movement detector 120, removes noise, and outputs a second puck movement signal mov2 after a second period of time which is shorter than the first period of time.

Here, the first and second filters 140 and 160 may use digital filters such as infinite impulse response (IIR) filters or finite impulse response (FIR) filters, which have the same amplitude characteristics and different delay time characteristics. In general, the IIR filter has a large delay time and the FIR filter has a small delay time. Generally, even in the same digital filter, the lower the order of the filter is, the larger the delay time is, and the higher the order of the filter is, the smaller the delay time is.

Accordingly, the first filter 140 may be implemented with a second IIR filter, and the second filter 160 may be implemented with a third FIR filter.

The puck movement determiner 180 receives the second puck movement signal mov2 from the second filter 160 and outputs a filter output cutoff signal FT_off to cut off the output of the first filter 140 according to whether the touch object contacts with and moves the puck in response to the second puck movement signal mov2.

The switch 150 transmits or cuts off the output of the first filter 140 in response to the filter output cutoff signal FT_off from the puck movement determiner 180. Here, the switch 150 may be implemented via software as well as via hardware such as a logic circuit.

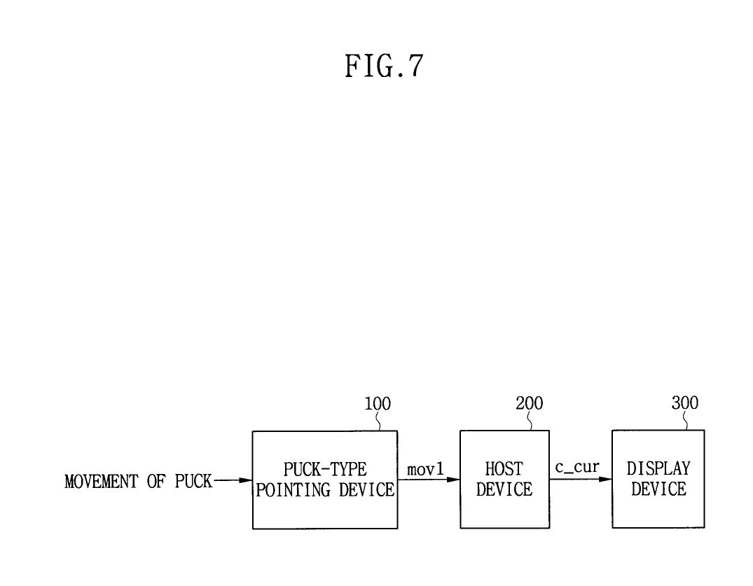

FIG. 7 is a schematic block diagram of a pointing system including the puck-type pointing device 100 in accordance with the exemplary embodiment of the present invention of FIG. 6, the pointing system including the puck-type pointing device 100, a host device 200, and a display device 300.

The function of each block will be described below.

The puck-type pointing device 100 detects the touch and movement information of the puck, filters the information with varying the delay time, and transmits or cuts off the first puck movement signal mov1 according to the movement information.

The host device 200 calculates the movement direction and distance of the puck and outputs a cursor control signal c_cur in response to the first puck movement signal mov1.

The display device 300 moves the cursor a distance equal to the moving distance of the puck in response to the cursor control signal c_cur and stops the cursor at a precise time point at which the movement of the puck stops when the puck returns to its center position.

Up to now, the cursor a distance is assumed to be equal to the moving distance of the puck. But, there is natural to apply other alternatives of mathematic functions that the cursor a distance is related to the moving distance of the puck as well as the moving speed of the puck. This is similar to use in mouse driver. For an example of the mathematic function is that the cursor at a distance is proportionally increasing with the moving distance of the puck.

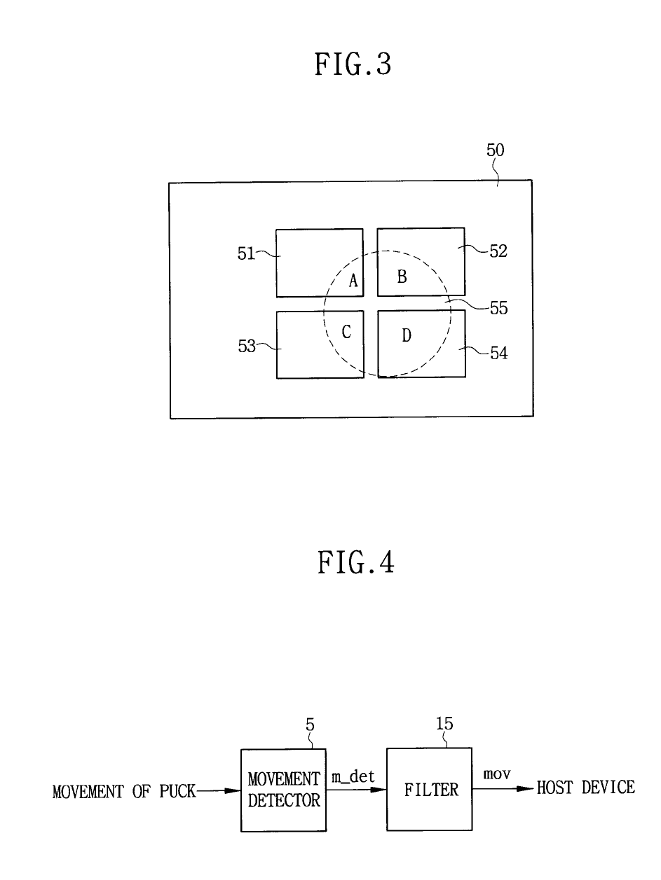

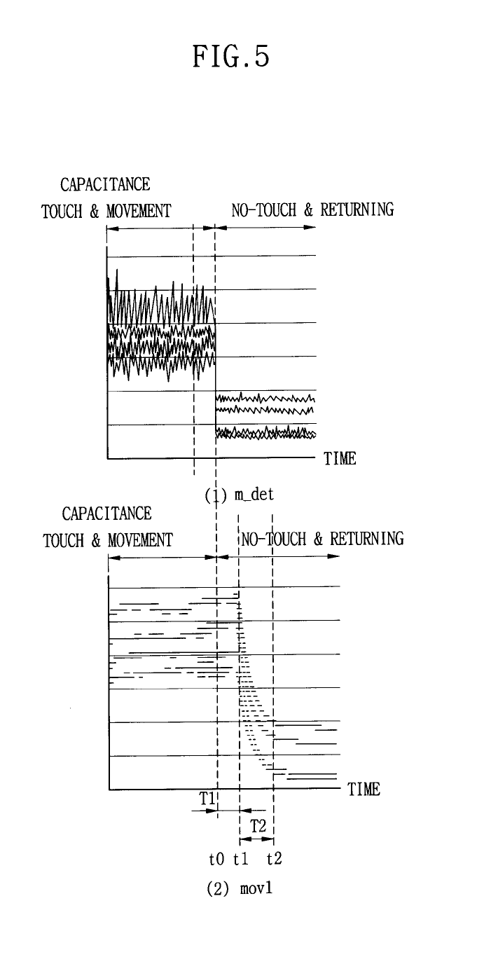

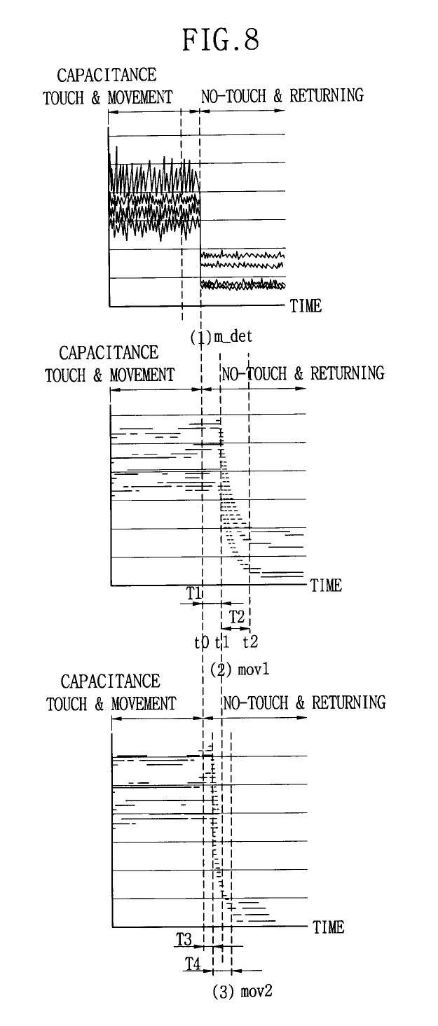

FIG. 8 is an operation waveform diagram of the puck-type pointing device in accordance with the exemplary embodiment of the present invention of FIG. 6, in which waveform (1) represents a delayed movement detection signal m_det of four channels, waveform (2) represents a first puck movement signal mov1 of four channels, and waveform (3) represents a second puck movement signal mov2 of four channels. The four channels are caused by the difference in the capacitance values measured at the overlapping portions between the electrode 55 of the puck and the surface electrodes 51 to 54 of FIG. 3.

When the touch object contacts and moves the puck, the movement detection signal m_det with noise is output at a high level indicating the corresponding capacitance values after the predetermined period of time T1, and the movement detection signal m_det with reduced noise is output at a low level indicating the corresponding capacitance values during the period from time point t0 at which the touch object is removed from the puck to time point t1 at which the predetermined period of time T1 elapses.

When the touch object is in contact with the pointing device and moves the pointing device, the first puck movement signal mov1 filtering out noise is produced at a high level indicating the corresponding capacitance values after the predetermined period of time T1, and the first puck movement signal mov1 filtering out noise is produced at a low level after a predetermined period of time T2 since the level gradually decays during the period from time point t1 at which the touch object is removed from the puck to time point t2 at which the predetermined period of time T2 elapses. Here, T1 is delay time of the first filter 140.

When the touch object contacts and moves the puck, the second puck movement signal mov2 filtering out noise is produced at a high level indicating the corresponding capacitance values after the predetermined period of time T3, and the second puck movement signal mov2 filtering out noise is output at a low level after a predetermined period of time T4 since the level rapidly decays at time point t0+T3 at which the touch object is removed from the puck. Here, T3 is delay time of the second filter 160.

Operation of the puck-type pointing device in accordance with the present invention will be described with reference to FIGS. 6 to 8 below.

For example, it is assumed that a user moves a cursor on a monitor of a laptop computer using the puck-type pointing device.

When the user moves a puck in the pointing device with his or her finger, the movement detector 120 detects the touch having a predetermined pressure and the movement of the puck from the user's finger as a touch object and detects that the touch object contacts and moves the puck. Then, the movement detector 120 outputs the movement detection signal m_det of four channels with noise at a high level indicating the corresponding capacitance values. Here, the puck 11 is assumed to be floating so that distance between the puck 11 on the surface 12 is decreasing when the user touches the puck.

The movement detection signal m_det of four channels has waveform (1) of FIG. 8, in which the capacitance values of the four surface electrodes 51 to 54 of FIG. 3 are output as four touch channels. When the touch object contacts and moves the puck, the movement detection signal m_det with noise is output at a high level indicating the corresponding capacitance values. When the user's finger is removed from the puck, the movement detection signal m_det without noise is immediately output at a low level indicating that the corresponding capacitance values detected by the electrode 55 of the puck and the surface electrodes 51 to 54 are reduced.

The first filter 140 receives the movement detection signal m_det delayed for the predetermined period of time T1, removes noise by low-pass filtering the signal, and outputs the first puck movement signal mov1 at a high level indicating the corresponding capacitance values until time instant t1.

The second filter 160 receives the movement detection signal m_det from the movement detector 120, removes noise by low-pass filtering the signal, and outputs the second puck movement signal mov2 delayed for the predetermined period of time T3 at a high level indicating the corresponding capacitance values until time instant t0+T3.

The puck movement determiner 180 receives the second puck movement signal mov2 of the high level from the second filter 160, determines that the user's finger contacts and moves the puck, and outputs the filter output cutoff signal FT_off at a low level to transmit the output of the first filter 140. The switch 150 receives the filter output cutoff signal FT_off of the low level from the puck movement determiner 180 and transmits the output of the first filter 140 in response thereto.

The host device receives the first puck movement signal mov1 of the high level from the switch 150 and moves the cursor on the display device such as a monitor in accordance with the movement direction and distance of the puck.

Then, when the user's finger is removed from the puck, the movement detector 120 recognizes that the pressure from the user's finger is rapidly reduced, detects that the touch and movement of puck by the touch object stop, and outputs the movement detection signal m_det of four channels with noise at a low level indicating the corresponding capacitance values after a predetermined period of time T1.

The first filter 140 receives the movement detection signal m_det delayed for the predetermined period of time T1, removes noise by low-pass filtering the signal, and outputs the first puck movement signal mov1 at a low level indicating the corresponding capacitance values after the first period of time T2. The second filter 160 receives the movement detection signal m_det from the movement detector 120, removes noise by low-pass filtering the signal, and outputs the second puck movement signal mov2 at a low level indicating the corresponding capacitance values after a second period of time T4.

Here, as shown in waveform (3) of FIG. 8, at time point t0+T3, the level of the second puck movement signal mov2 rapidly decays, and thus the second puck movement signal mov2 from which noise is removed is output at a low level indicating the corresponding capacitance values after the second period of time T4 which is also shorter than the first period of time T2.

The puck movement determiner 180 receives the second puck movement signal mov2 of the low level from the second filter 160, determines that the touch and movement of the puck stop, and outputs the filter output cutoff signal FT_off at a high level to cut off the output of the first filter 140. Here, determiner 180 should be made before or equal to T1.

The switch 150 cuts off the output of the first filter 140 in response to the filter output cutoff signal FT_off of the low level from the puck movement determiner 180. Since the host device does not receive the first puck movement signal mov1 from the switch 150, it stops the movement of the cursor on the display device.

Although the description has been given with respect to the case where high impedance or floated conductive puck is used for a better understanding of the present invention, an elastic material may be filled between the puck and the surface electrodes 51 to 54, or the distance therebetween may be changed by an external pressure, in the case where a finger is removed from the puck, such that all the capacitance values are reduced.

That is, even in the case where a mechanical switch such as a dome switch is located at the bottom of the puck, it takes time for the distance between the puck and the surface electrodes 51 to 54 to settle to a constant value, and noise generated by vibration (chattering) caused when the dome switch detects the removal of the user's finger from the puck should be removed by the second filter 160.

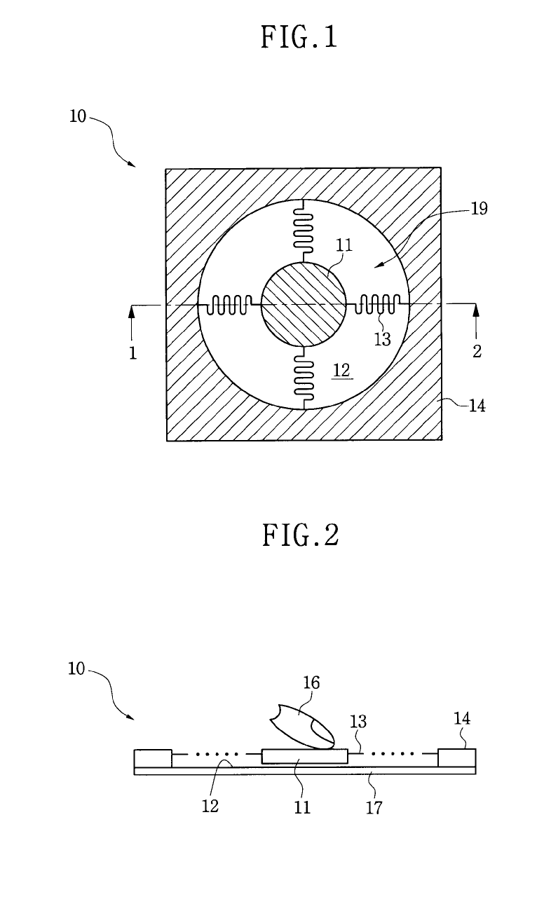

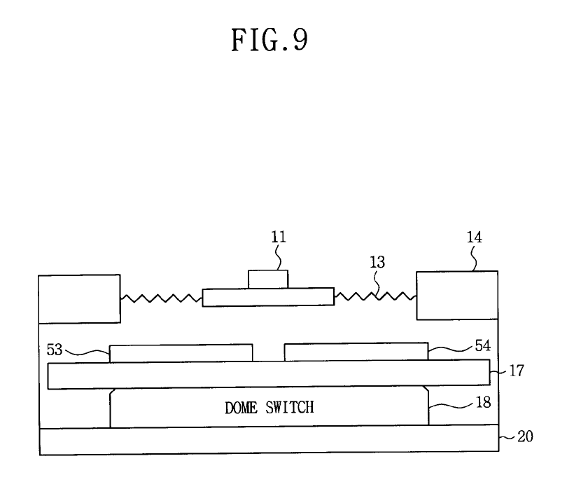

FIG. 9 is a cross-sectional view of the puck-type pointing device 10 of FIG. 1 to which another exemplary embodiment of the present invention is applied, taken along line 1-2. The puck-type pointing device comprises a puck 11, springs 13, a side 14 of the puck field of motion, surface electrodes 53 and 54, a first substrate 17, a dome switch 18, and a second substrate 20.

The operation of the puck-type pointing device 10 in accordance with another exemplary embodiment of the present invention will be described with reference to FIGS. 6 and 9 below.

When the puck 11 moves over a surface 12 of the substrate 17 within a puck field of motion 19 in response to a lateral force applied to the puck 11 and the user releases the pressure applied to the puck 11 by removing the user's finger, the puck 11 is returned to its center position by the springs 13 that connect the puck to the side 14 of the puck field of motion in the same manner as the conventional puck-type pointing device 10 of FIG. 1.

However, the puck-type pointing device 10 in accordance with another exemplary embodiment of the present invention has a characteristic feature in that, when a signal input from the dome switch 18 is an analog value, the second filter 160 of FIG. 6 is implemented with a peak detector, and when the signal input from the dome switch 18 is a digital value, the second filter 160 is implemented with an accumulator accumulating the value a plurality of times.

The value filtered in the above manner is compared with a threshold value set in the puck movement determiner 180 and, in this embodiment, the delay times of the second filter 160 and the puck movement determiner 180 are set to be smaller than that of the first filter 140.

According to the puck-type pointing device, the pointing system including the same, and the pointing method thereof in accordance with the present invention, when the user's finger contacts and moves the puck, the cursor moves a distance corresponding to the moving distance of the puck, and when the puck returns to its center position as the user's finger is removed from the puck, the time required for the touch signal to decay is reduced compared to the conventional case. Thus, it is possible to easily detect the precise time point t0 at which touch and movement of the puck stop. As a result, the mouse mode is enabled in which the cursor can be stopped at a precise position at time point t0 at which touch and movement of the puck stop.

Although operation of the pointing device, the pointing system, and the pointing method have been described with respect to detection of touch and movement for a better understanding of the present invention, it is needless to say that the puck-type pointing device, the pointing system including the same, and the pointing method thereof in accordance with the present invention can be applied to a proximity detector which detects the proximity of a nearby object based on proximity detection to determine whether the nearby object approaches a puck and outputs a proximity detection signal indicating a corresponding capacitance value.

Moreover, although operation has been described with respect to the case where an elastic material is interposed between the puck and the surface electrodes at the bottom thereof, it is needless to say that the puck-type pointing device, the pointing system including the same, and the pointing method thereof in accordance with the present invention can be applied to the case where the distance between the puck and the surface electrodes at the bottom thereof is fixed, since the background noise caused by the finger is applied to the surface electrodes in the same manner.

Furthermore, although the description has been given with respect to the case where the movement of the puck is detected by the change in capacitance, it is needless to say that the puck-type pointing device, the pointing system including the same, and the pointing method thereof in accordance with the present invention can be applied to various structures in which the movement of the puck is detected by measuring an electromagnetic field intensity or a radio frequency (RF) electric field.

The foregoing description of exemplary embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

According to the puck-type pointing device, the pointing system including the same, and the pointing method thereof in accordance with the present invention, it is possible to easily detect a precise time point at which touch and movement of the puck stop when the puck returns to its center position as the touch object is removed from the puck, thus preventing malfunction due to continuous movement of the cursor.

What is claimed is:

1. A puck-type pointing device, comprising:
a movement detection unit detecting information regarding touch and movement of a puck by a touch object and outputting a movement detection signal;
a first signal processing unit receiving the movement detection signal, removing noise, and outputting a first puck movement signal after a first period of time;
a second signal processing unit receiving the movement detection signal, removing noise, and outputting a second puck movement signal after a second period of time which is shorter than the first period of time; and
a puck movement signal transmitting unit transmitting or cutting off the first puck movement signal according to the movement information in response to the second puck movement signal.

2. The puck-type pointing device of claim 1, wherein the puck movement signal transmitting unit comprises:
a puck movement determiner outputting a filter output cutoff signal at a high level in response to the second puck movement signal when the first puck movement signal is transmitted and outputting the filter output cutoff signal at a low level when the first puck movement signal is cut off; and
a switch transmitting or cutting off the first puck movement signal in response to the filter output cutoff signal.

3. The puck-type pointing device of claim 1, wherein the first and second signal processing units comprise digital filters having the same amplitude characteristics.

4. The puck-type pointing device of claim 1, wherein the movement detection unit is a proximity detection unit that determines whether a nearby object approaches the puck and outputs a proximity detection signal indicating a corresponding capacitance value.

5. A puck-type pointing system, comprising:
a puck-type pointing device detecting information regarding touch and movement of a puck by a touch object and transmitting or cutting off a first puck movement signal, filtering with varying a delay time, according to the movement information;
a host device calculating movement direction and distance of the puck and outputting a cursor control signal in response to the first puck movement signal; and
a display device moving a cursor a distance corresponding to the moving distance of the puck in response to the cursor control signal and stopping the cursor at a precise time point at which the movement of the puck stops when the puck returns to its center position.

6. The puck-type pointing system of claim 5, wherein the puck-type pointing device comprises:
a movement detection unit detecting information regarding the touch and movement of the puck by the touch object and outputting a movement detection signal;
a first signal processing unit receiving the movement detection signal, removing noise, and outputting a first puck movement signal after a first period of time;
a second signal processing unit receiving the movement detection signal, removing noise, and outputting a second puck movement signal after a second period of time which is shorter than the first period of time; and
a puck movement signal transmitting unit transmitting or cutting off the first puck movement signal according to the movement information in response to the second puck movement signal.

7. The puck-type pointing system of claim 6, wherein the puck movement signal transmitting unit comprises:
a puck movement determiner outputting a filter output cutoff signal at a high level in response to the second puck movement signal when the first puck movement signal is transmitted and outputting the filter output cutoff signal at a low level when the first puck movement signal is cut off; and
a switch transmitting or cutting off the first puck movement signal in response to the filter output cutoff signal.

8. The puck-type pointing system of claim 6, wherein the first and second signal processing units comprise digital filters having the same amplitude characteristics.

9. The puck-type pointing system of claim 6, wherein the movement detection unit is a proximity detection unit that determines whether a nearby object approaches the puck and outputs a proximity detection signal indicating a corresponding capacitance value.

10. The puck-type pointing system of claim 5, wherein the host device moves a cursor in accordance with the movement direction and distance of the puck when the first puck movement signal is applied at a high level and stops the cursor when the first puck movement signal is applied at a low level.

11. A puck-type pointing method, comprising:
a movement detection step of detecting information regarding touch and movement of a puck by a touch object and outputting a movement detection signal;
a first signal processing step of receiving the movement detection signal, removing noise, and outputting a first puck movement signal after a first period of time;
a second signal processing step of receiving the movement detection signal, removing noise, and outputting a second puck movement signal after a second period of time which is shorter than the first period of time; and
a puck movement signal transmitting step of transmitting or cutting off the first puck movement signal according to the movement information in response to the second puck movement signal.

12. The puck-type pointing method of claim 11, wherein the puck movement signal transmitting step comprises:
a puck movement detection step of outputting a filter output cutoff signal at a high level in response to the second puck movement signal when the first puck movement signal is transmitted and outputting the filter output cutoff signal at a low level when the first puck movement signal is cut off; and
a switching step transmitting or cutting off the first puck movement signal in response to the filter output cutoff signal.

13. The puck-type pointing method of claim 11, wherein the movement detection step is a proximity detection step of determining whether a nearby object approaches the puck and outputting a proximity detection signal indicating a corresponding capacitance value.

14. The puck-type pointing method of claim 11, wherein in the first and second signal processing steps, digital filters having the same amplitude characteristics are used.
